(19) United States
(12) Patent Application Publication
(10) Pub. No.: US 2017/0314777 A1
(43) Pub. Date: Nov. 2, 2017

(54) MultiLED Fan Controller Aparatus

(71) Applicant: IN WIN DEVELOPMENT, INC., Taoyuan Hsien (TW)

(72) Inventor: WEN-HSIEN LAI, Taoyuan Hsien (TW)

(73) Assignee: IN WIN DEVELOPMENT, INC., Taoyuan Hsien (TW)

(21) Appl. No.: 15/143,378

(22) Filed: Apr. 29, 2016

(51) Int. Cl. F21V 33/00; H05B 33/08; F04D 25/06; F04D 19/00; F04D 27/00; F21Y 2115/10

(52) U.S. Cl. CPC F21V 33/0096; H05B 33/0857; H05B 33/0815; F04D 27/004; F04D 25/06; F04D 19/002; F21Y 2115/10

(57) ABSTRACT

The present invention discloses a multiLED fan controller apparatus, which is provided with various addressable RGB (Red-Green-Blue) LEDs. Each addressable RGB LED is built in with an IC (Integrated Circuit) control chip, which is equipped with a one-wire bus control function and can be connected in a series freely. The LED fans are only provided with windows of a single input and a single output that all the addressable RGB LEDs can be controlled. In addition, all the addressable RGB LEDs are controlled individually by a controller to result in various lighting effects through the change in output signals. The lighting can be adjusted remotely by the controller, or can be adjusted by a dedicated software program.

### BACKGROUND OF THE INVENTION

### a) Field of the Invention

The present invention relates to an LED (Light Emitting Diode) fan control device, which connects multiple fans by wiring each one to a single controller device. By doing this, each individual LED light and the fan's rotational speed can be adjusted.

### b) Description of the Prior Art

A conventional fan controller device allow user to control fan(s) by altering their rotational speeds and control the LEDs as a series, but only as a series and not individually. Referring to FIG. 1, several conventional LED fans 100 have to be connected electrically with a controller 200 with an independent transmission line 101, 102, 103 respectively. The LED fans 100 are only provided with a single function of adjusting the lights as a series, and the wrapped transmission lines 101, 102, 103 will affect the entire appearance, which needs to be improved.

### SUMMARY OF THE INVENTION

The primary objective of the present invention is to provide an LED fan controller device that connects multiple fans, and synchs each individual LED light to the user's preference, while maintaining the speed of each fan.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a conventional LED fan controller device, which connects several LED fans.

FIG. 2 shows a schematic view of an LED fan controller device, which links several LED fans, according to the present invention.

FIG. 3 shows a planar view of an LED fan, according to the present invention.

FIG. 4 shows a circuit diagram illustrating that a built-in LED driver IC is used to control multiple LED fans by linking them together, according to the present invention.

FIG. 5 shows a circuit diagram illustrating that an LED driver IC is used to control multiple LED fans by linking them together, according to the present invention.

FIG. 6 shows a circuit diagram illustrating that a microcontroller is used to control multiple LED fans by linking them together, according to the present invention.

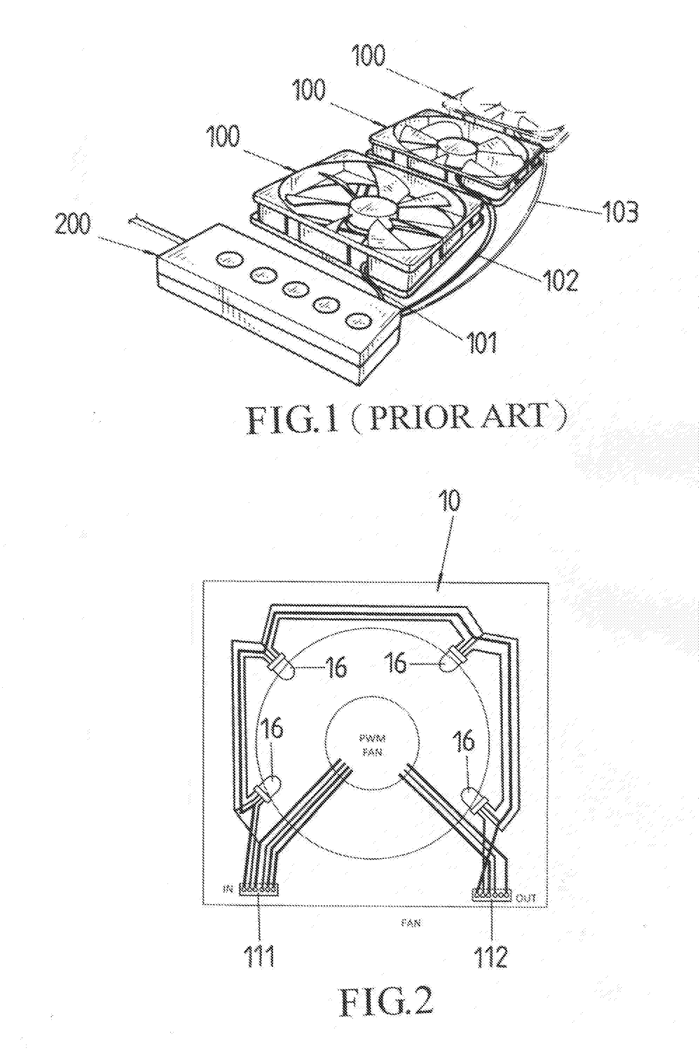

### DETAILED DESCRIPTION OF THE PREFERRED EMBODIMENTS

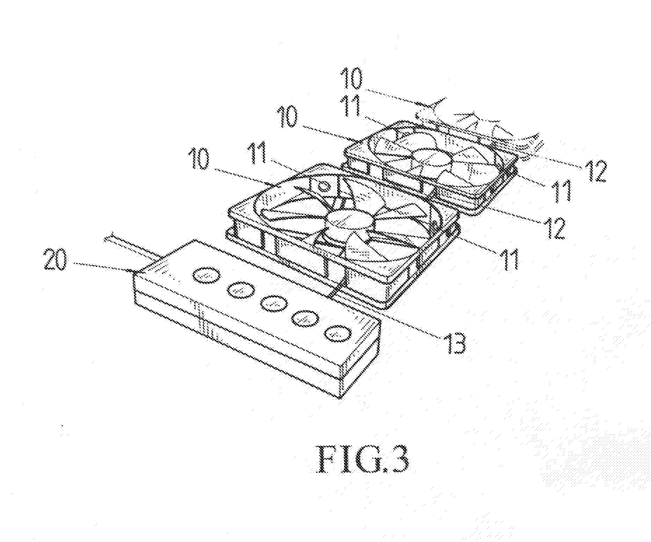

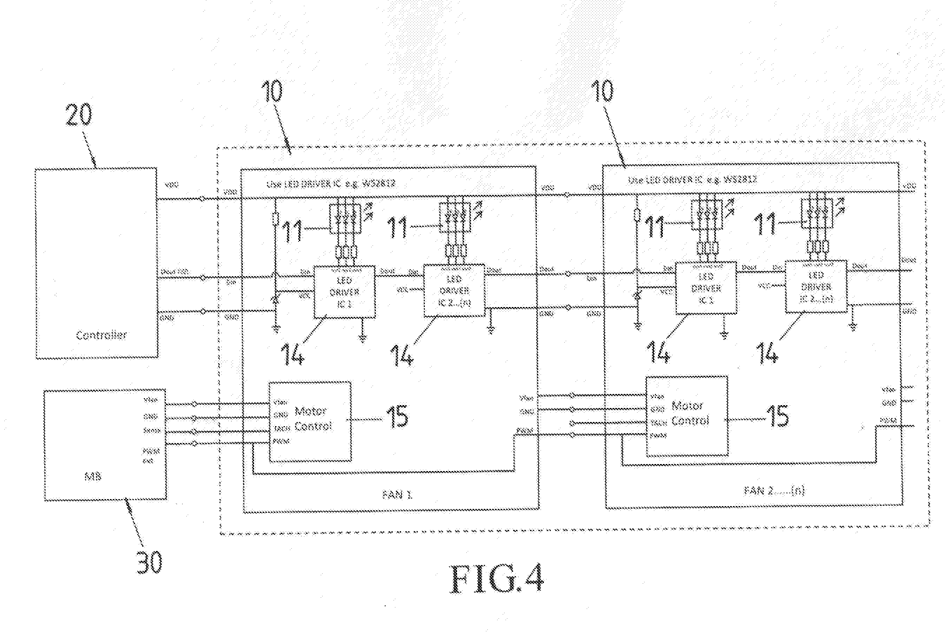

Referring to FIG. 2, which shows a schematic view of the appearance of the fan controller device that links multiple LED fans, according to the present invention, wherein each LED fan 10 on the LED fan controller device of the present invention is provided with various addressable RGB (Red-Green-Blue) LEDs 16. Each addressable RGB LED 16 is built in with an IC (Integrated Circuit) control chip which is equipped with a one-wire bus control function and can be connected in a series freely. The LED fan 10 is only provided with windows of a single input 111 and a single output 112 that all the addressable RGB LEDs 16 can be controlled. In addition, all the addressable RGB LEDs 16 are controlled individually by a controller 20 (as shown in FIG. 3) to result in even more complex and expressive lighting effects through the change in output signals. The lighting effects can be adjusted remotely by the controller 20 or can be altered by a dedicated program in an operating system.

Referring to FIG. 3, which shows a planar view of an LED fan, according to the present invention, wherein LED fans 10 are linked together using a single transmission line 12, and LED fans 10 are linked together with controller 20 by another transmission line 13.

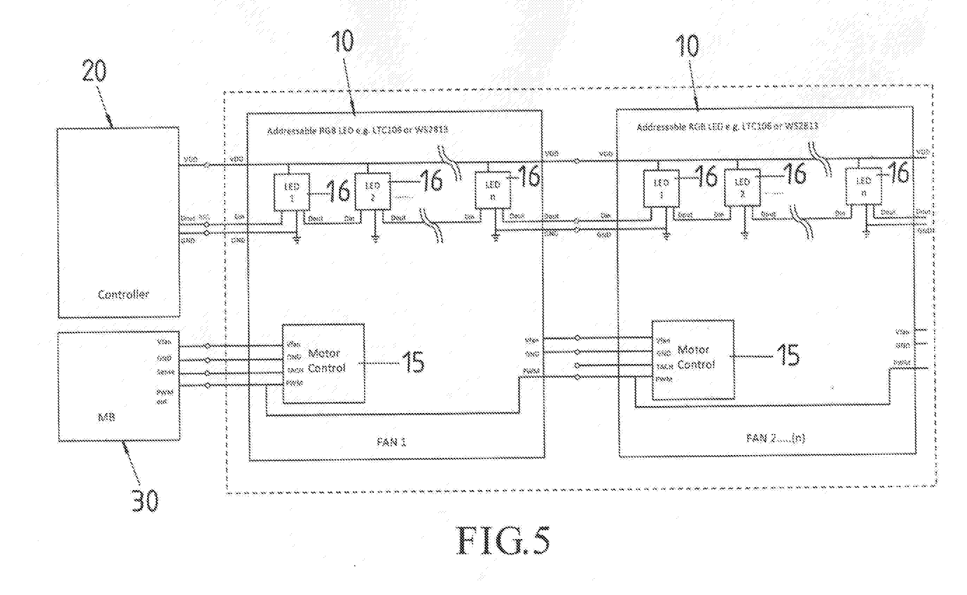

Referring to FIG. 4, which shows a circuit diagram illustrating that a built-in LED driver IC is used to control multiple LED fans linked together, According to the first embodiment of the present invention, LED fans 10 are provided respectively with various addressable RGB LEDs 16 of a built-in LED driver IC. The various addressable RGB LEDs 16 are connected in a series, and the addressable RGB LEDs 16 linked together with the controller 20. Each LED fan 10 is provided respectively with a control motor 15 and each control motor 15 linked together with a mother board (MB) 30.

Referring to FIG. 5, which shows a circuit diagram illustrating that an LED driver IC is used to control multiple LED fans that are linked together. According to the second embodiment of the present invention, LED fans 10 are provided respectively with RGB LEDs 11, and each RGB LEDs 11 uses an LED driver IC 14 to drive the color of light. The neighboring LED fans 10 are linked with one another, and the LED driver IC 14 is linked with the controller 20. Furthermore, each LED fan 10 is provided respectively with a control motor 15, and each control motor 15 is linked with mother board (MB) 30.

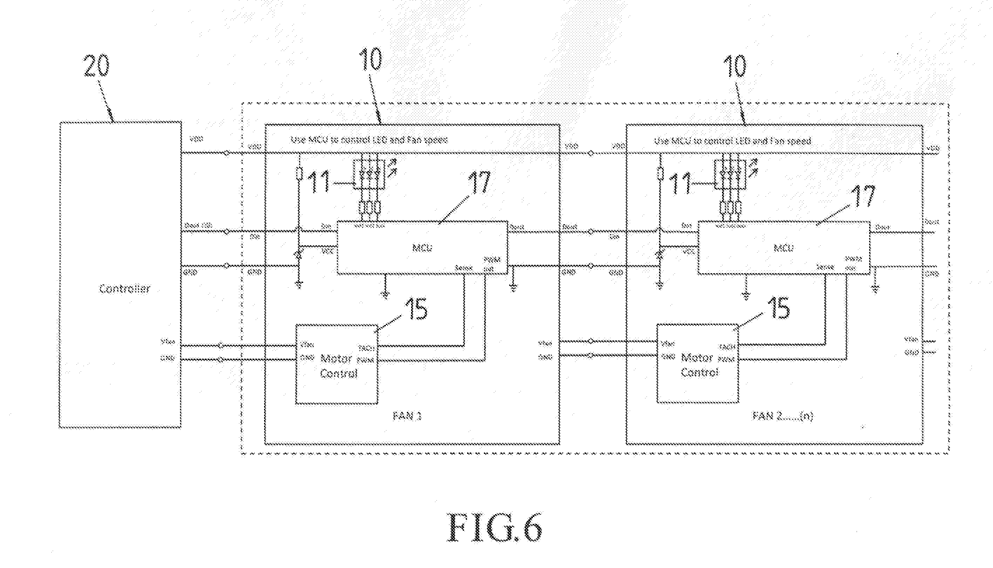

Referring to FIG. 6, which shows a circuit diagram illustrating that a microcontroller is used to control multiple LED fans linked together, According to the third embodiment of the present invention, LED fans 10 are provided with a microcontroller (MCU) 17, and each microcontroller 17 drives an RGB LED 11 and adjusts the rotational speed of the LED fan 10 using the PWM (Pulse Width Modulation) technique. The neighboring microcontrollers 17 are linked with one another, and the microcontroller 17 is linked with the controller 20. Each LED fan 10 is provided with a control motor 15, and at the end of each control motor 15 is linked with the microcontroller 17; whereas, the control motor 15 is linked with the controller 20.

In conclusion, according to the above description of the embodiments of the present invention, an LED fan controller device can adjust each individual LED light on multiple LED fans while simultaneously control all fan speeds too.

It is of course to be understood that the embodiments described herein is merely illustrative of the principles of the invention and that a wide variety of modifications may be effected by people's skill level in the art without departing from the spirit and scope of the invention as set forth in the following claims.

What is claimed is:

1. A multiLED fan controller apparatus, wherein a device can control each LED light on multiple fans and also the rotation speed of each LED fans by being linked together on the single device, The LED fans on the device use various addressable RGB LEDs, each addressable RGB LED is built in with an IC control chip which is equipped with a one-wire bus control function and is connected in a series freely, The LED fans are provided with windows of a single input and a single output to control all the addressable RGB LEDs, Each addressable RGB LED is controlled individually by a controller to result in more complex and expressive lighting effects through the change in output signals, The light effect changes are adjusted by the controller, the LED fans are linked with one another by a single transmission line, and the LED fan is linked with the controller by another transmission line.

2. The multiLED fan controller apparatus according to claim 1, wherein the multiple LED fans are provided respectively with various addressable RGB LEDs of a built-in LED driver IC, The various addressable RGB LEDs are connected in a series, and the addressable RGB LED is linked with the controller; Each LED fan is provided with a control motor and each control motor is linked with a mother board (MB).

3. The multiLED fan controller apparatus according to claim 1, wherein the multiple LED fans are provided with RGB LEDs, and each RGB LED uses an LED driver IC to drive the color of light, The neighboring LED fans are linked with one another, and the LED driver IC is linked with the controller; Furthermore, each LED fan is provided with a control motor, and each control motor is linked with a mother board (MB).

4. The multiLED fan controller apparatus according to claim 1, wherein the multiple LED fans are provided with a microcontroller (MCU), Each microcontroller drives an RGB LED, and adjusts the rotational speed of the LED fan using the PWM (Pulse Width Modulation) technique, The neighboring microcontrollers are linked with one another, and the microcontroller is linked with the controller, Each fan is provided with a control motor, and at the end of each control motor is linked with the microcontroller; whereas, the control motor is linked with the controller.
